(19) United States
(12) Patent Application Publication
(10) Pub. No.: US 2012/0154429 A1
(43) Pub. Date: Jun. 21, 2012

(54) APPARATUS AND METHOD FOR SMOOTHED ALIASING ON A TWO-DIMENSIONAL PLANE

(75) Inventors: Jong-Keun Cho, Ansan-si (KR); Byoung-Ho YUN, Seoul (KR); Jung-Bum KIM, Hwaseong-si (KR)

(73) Assignee: SAMSUNG ELECTRONICS CO., LTD., Suwon-si (KR)

(21) Appl. No.: 13/332,099

(22) Filed: Dec. 20, 2011

(30) Foreign Application Priority Data
Dec. 20, 2010 (KR) 10-2010-0130546

(51) Int. Cl. G09G 5/00

(52) U.S. Cl. 345/611

(57) ABSTRACT

An apparatus for smoothed aliasing on a two-dimensional plane includes a data input unit for receiving at least one piece of data input by a user, a graphic engine processing unit for generating a quadrangle including a form of the at least one piece of data and differently applying transparency to at least one transparent area included in the quadrangle, and a display unit for displaying the at least one piece of data processed by the graphic engine processing unit.

### CROSS-REFERENCE TO RELATED APPLICATION(S) AND CLAIM OF PRIORITY

The present application is related to and claims priority under 35 U.S.C. §119(a) to a Korean Patent Application filed in the Korean Intellectual Property Office on Dec. 20, 2010 and assigned Serial No. 10-2010-0130546, the contents of which are incorporated herein by reference.

### TECHNICAL FIELD OF THE INVENTION

The present invention relates generally to anti-aliasing, and more particularly, to an apparatus and method for smoothed aliasing on a two-dimensional plane.

### BACKGROUND OF THE INVENTION

Computer use has generally increased due to technological innovation. A representative example of the broadened computer use involves computer graphics for editing or processing lines, figures, or images using a computer.

In most computer implementations, almost all data is represented with digital values. Because of this, an undesirable phenomenon often occurs of converting an analog phenomenon in a nature system to a digital value, such as aliasing, is frequently observed. In particular, aliasing in graphic processing is recognized as a phenomenon in which each edge of a polygon may be generated as a zigzag pattern or other type of figure is displayed incorrectly. This may be caused by a pixel size or resolution of a display in which pixels are not clearly distinguished by the sense of sight of its user. That is, because a computer uses pixels smaller than those visible with a user's eyes and draws a line or figure by using a combination of those pixels, aliasing often occurs.

Based on this feature, aliasing may exist in computer graphics that use multiple pixels. The aliasing is generally an unavoidable phenomenon on a display structure in which a line or figure is drawn on a pixel basis. In particular, when a line or figure is drawn in a diagonal orientation, aliasing may be easily found.

FIG. 1 illustrates an example display showing the occurrence of aliasing. Referring to FIG. 1, while aliasing does not generally occur when a horizontal or vertical line are drawn, aliasing occurs when lines are drawn in a diagonal orientation. In addition, even when a lines that is only partially diagonal is drawn, aliasing may still occur.

Various anti-aliasing methods have been implemented, wherein one technique involves sampling pattern on a screen.

FIGS. 2A and 2B illustrate an existing anti-aliasing process using a sampling pattern. In detail, FIGS. 2A and 2B illustrate a process of smoothed aliasing occurring when a line is drawn.

FIG. 2A shows a line or figure formed with a combination of pixels, and FIG. 2B shows a line or figure to which the sampling pattern is applied. That is, the aliasing is smoothed by averaging samples of neighboring pixels and filling some additional pixels around pixels forming an existing line or figure according to an averaging result.

However, since this method must obtain the samples of neighboring pixels one by one and average the obtained samples, computation may increase significantly, and since aliasing is smoothed by use of additional pixels, the smoothed result may not be satisfactory.

### SUMMARY OF THE INVENTION

To address the above-discussed deficiencies of the prior art, it is a primary object to provide an apparatus and method for smoothed aliasing graphic data by generating an area including a form of the graphic data and applying different transparencies to transparent areas included in the generated area.

According to one aspect of the present invention, there is provided an apparatus for smoothed aliasing on a two-dimensional plane including a data input unit for receiving at least one piece of data input by a user, a graphic engine processing unit for generating a quadrangle including a form of the at least one piece of data and differently applying transparency to at least one transparent area included in the quadrangle, and a display unit for displaying the at least one piece of data processed by the graphic engine processing unit.

According to another aspect of the present disclosure, a method of smoothed aliasing on a two-dimensional plane includes receiving at least one piece of data input by a user, generating a quadrangle including a form of the at least one piece of data, differently applying transparency to at least one transparent area included in the quadrangle, and displaying the at least one piece of data.

According to another aspect of the present disclosure, executable code implemented on a computer-readable medium is configured to perform receiving at least one piece of data input by a user, generating a quadrangle including a form of the at least one piece of data, differently applying transparency to at least one transparent area included in the quadrangle, and displaying the at least one piece of data.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example diagram of the occurrence of aliasing;

FIGS. 2A and 2B illustrate an existing anti-aliasing technique using a sampling pattern;

FIG. 3 illustrates an example apparatus for smoothed aliasing according to an embodiment of the present disclosure;

FIG. 4 illustrates an example generation of a quadrangle including a primitive according to an embodiment of the present disclosure;

FIG. 5 illustrates an example application of transparency on a line segment basis according to an embodiment of the present invention;

FIG. 6 illustrates an example method of smoothed aliasing according to an embodiment of the present disclosure;

FIGS. 7A to 7C illustrate example before and after diagrams for smoothed aliasing according to an embodiment of the present disclosure;

FIGS. 8A and 8B illustrate an example result shown after smoothed aliasing on a rounding part according to an embodiment of the present disclosure; and

FIGS. 9A and 9B illustrate example displays that may be generated on a screen after smoothed aliasing according to an embodiment of the present disclosure.

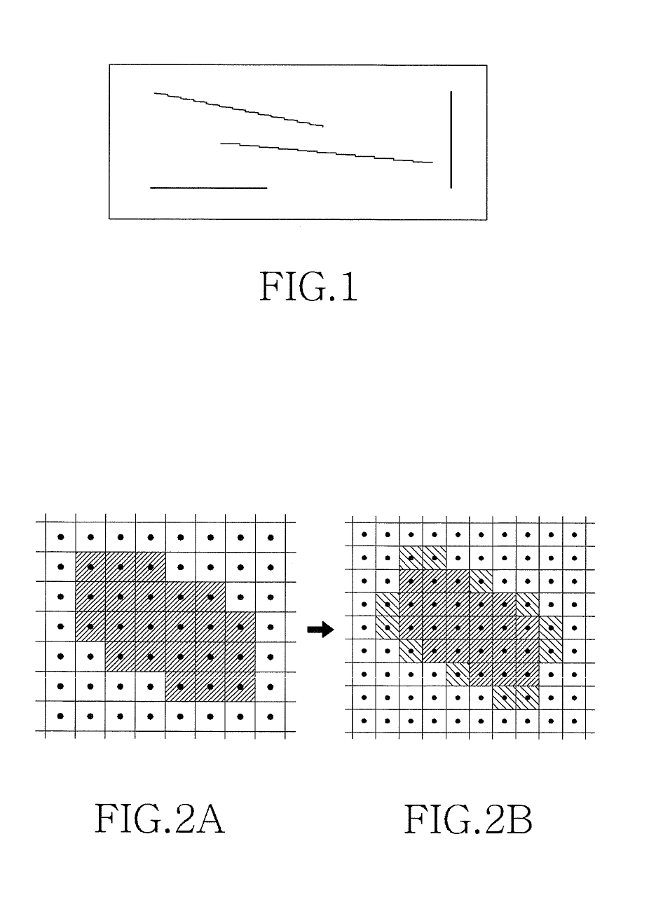

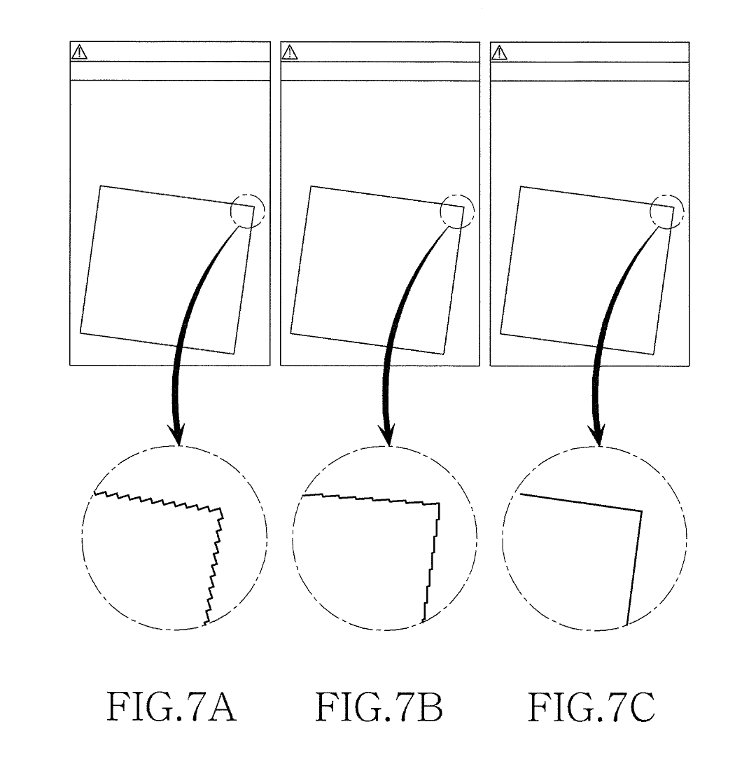

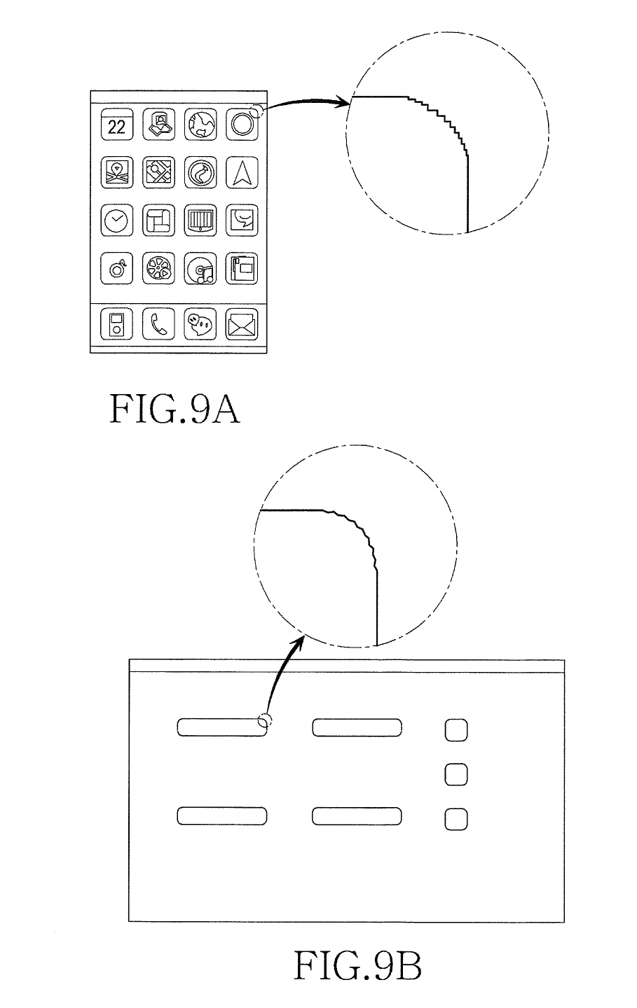

NOTE: Please amend drawings to include only black-and-white imagery. Color drawings included with a patent application filed in the U.S. requires a petition for allowance of the drawings along with additional petition fees. It appears as though FIGS. 7A through 7C may be easily replaced with black-and-white images. Additionally, we believe the texture of FIGS. 9A and 9B may be easily shown with enlarged images in black-and-white showing the differences in edge texture.

### DETAILED DESCRIPTION OF THE INVENTION

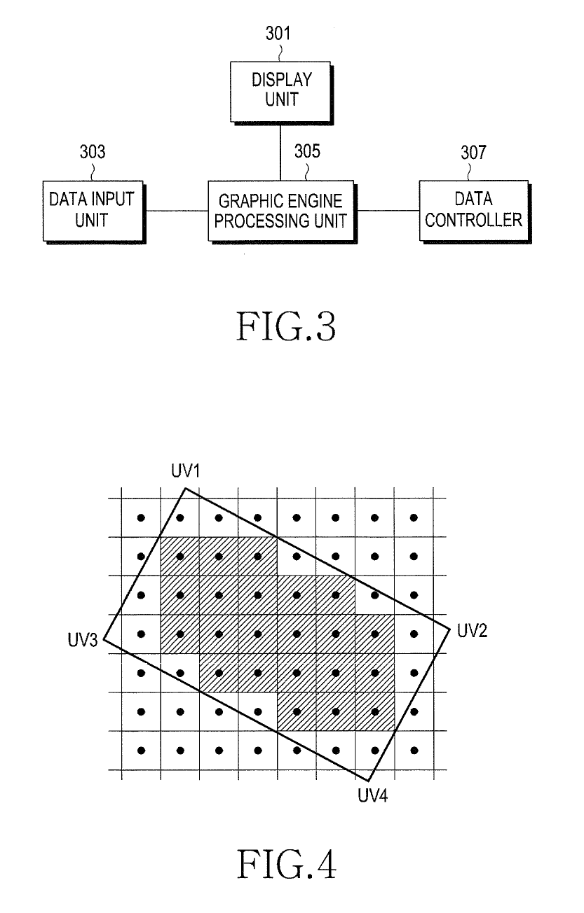

FIGS. 3 through 9B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged graphic processing devices. In the following description, although many specific items, such as components of a concrete circuit, are shown, they are only provided to help general understanding of the present invention, and it will be understood by those of ordinary skill in the art that these specific items can be modified or changed within the spirit and scope of the present invention.

FIG. 3 illustrates an example apparatus for smoothed aliasing according to an embodiment of the present disclosure.

The apparatus of FIG. 3 includes a display unit 301, a data input unit 303, a graphic engine processing unit 305, and a data controller 307.

Referring to FIG. 3, the display unit 301 outputs a primitive, such as a line or figure that may be inputted by a user or from some other mechanism. The primitive represents an element forming a line, a circle, a curve, or a polygon, which is substantially drawable, storable, or operable by a computer graphic program In graphic processing, a line of often considered to be the most fundamental primitive. Even the rounding portions of a circle or curve may be represented by a set of lines. In this embodiment, the display unit 301 may directly output at least one inputted primitive or output at least one primitive processed by the graphic engine processing unit 305.

The data input unit 303 receives the at least one inputted primitive and transmits the received at least one primitive to the graphic engine processing unit 305. The graphic engine processing unit 305 generates a quadrangle including a form of the at least one primitive and extracts coordinate values of the edges of the quadrangle. In this embodiment, the coordinate values of the edges of the quadrangle are UV1, UV2, UV3, and UV4. The graphic engine processing unit 305 also redefines coordinate values of edges based on line segments identified by the data controller 307, calculates an alpha value for interpolation by determining a transparent area or an opaque area with respect to each line segment, and applies the calculated alpha value to the transparent area. The alpha value indicates transparency in the line segment and may vary according to each line segment.

The data controller 307 divides the quadrangle including the input at least one primitive to a specified number of line segments and redefines coordinate values of edges based on the divided line segments.

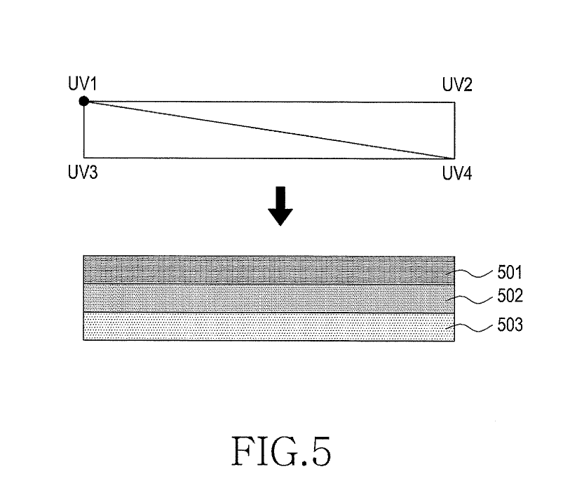

A process of generating a quadrangle including at least one primitive will now be described with reference to the block diagram of FIG. 4.

FIG. 4 illustrates an example quadrangle that may be generated including at least one primitive according to an embodiment of the present invention.

A range of the quadrangle including at least one primitive that is shown in FIG. 4 may be changed by the user. That is, the coordinate values UV1, UV2, UV3, and UV4 of the four edges of the quadrangle may be differently set by the user, and the number of line segments to be divided may also vary according to the change of the coordinate values UV1, UV2, UV3, and UV4. A specified number of line segments are divided for the user to more smoothly view the quadrangle by changing a transparency to be applied to a transparent area of each line segment. That is, because transparent areas included in the line segments may be different from each other, aliasing may be reduced by differently setting the transparency to be applied to each line segment.

A process of applying transparency to each line segment will now be described.

FIG. 5 illustrates an example application of a transparency on a line segment basis, according to an embodiment of the present disclosure.

A quadrangle including a primitive that is shown in FIG. 5 is divided into first, second, and third line segments 501, 502, and 503 in a vertical orientation, and different transparencies are applied to the first, second, and third line segments 501, 502, and 503 according to a range of a transparent area included in each of the first, second, and third line segments 501, 502, and 503. For example, if a range of a transparent area is larger in the first line segment 501, the second line segment 502, and the third line segment 503, the transparency of the second line segment 502 may be configured to be higher than that of the first line segment 501, and the transparency of the third line segment 503 may be configured to be higher than that of the second line segment 502. A line segment dividing orientation is parallel to a primitive's orientation. This is because the multiple transparent areas are clearly different according to each line segment, and accordingly, anti-aliasing can be performed by applying different transparencies to the first, second, and third line segments 501, 502, and 503.

That is, anti-aliasing can be performed by dividing a quadrangle having at least one primitive into a specified number of line segments and applying a transparency differently per line segment to a transparent area, instead of smoothed aliasing by filling additional pixels around existing pixels by using neighboring pixels according to the prior art.

Aliasing has been typically smoothed by filling additional pixels around existing pixels according to the prior art. In other words, while conventional techniques for anti-aliasing is limited since the minimum unit from which anti-aliasing may be applied is a pixel according to the prior art, anti-aliasing according to the present disclosure by applying different transparency to each of specific areas of each of the pixels. This is because transparency of each of a plurality of transparent areas of a quadrangle including a primitive may be adjusted rather than filling additional pixels around existing pixels.

Although three line segments are shown in FIG. 5, any number of line segments may be manipulated. For example, by increasing the number of line segments from 3 to 7, more detailed anti-aliasing may be performed.

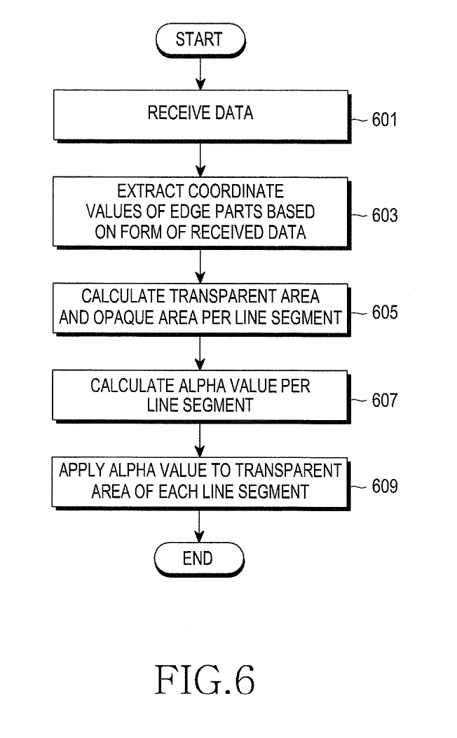

FIG. 6 illustrates a method of smoothed aliasing according to an embodiment of the present disclosure.

Referring to FIG. 6, in step 601, the apparatus of FIG. 3 receives data. The data indicates at least one primitive, such as a line or figure, and when the data is received, the apparatus of FIG. 3 determines a type of the received data. Types of received data may include a line, a circle, a curve, and/or a polygon, in which the most fundamental primitive is a line. If a type of the received data is determined, coordinate values of edges according to the determined type of the received data are extracted in step 603. That is, coordinate values of edges with respect to at least one primitive are extracted. The coordinate values may be changed according to settings by the user, and a quadrangle may be generated by connecting the coordinate values with each other. The generated quadrangle basically includes at least one primitive.

In step 605, the generated quadrangle is divided into a specified number of line segments, and transparent areas and opaque areas of the line segments are calculated. A line segment dividing orientation is parallel to a primitive's orientation. In step 607, a transparency alpha value per line segment is calculated based on the calculated transparent areas and opaque areas. Since each line segment may have a different range or size of transparent area, the calculated alpha values of the line segments may also be different from each other. In step 609, the calculated alpha value per line segment is applied to a transparent area of each line segment. That is, an alpha value varies according to which line segment a transparent area may be included in. For example, a relatively low transparency alpha value is applied to a line segment having a small range of transparent area, and a relatively high transparency alpha value is applied to a line segment having a large range of transparent area.

FIGS. 7A to 7C illustrate example before and after diagrams for smoothed aliasing according to an embodiment of the present disclosure. FIG. 7A shows a figure before smoothed aliasing, FIG. 7B shows a result after smoothed aliasing in an existing method of sampling pixels, and FIG. 7C shows a result after smoothed aliasing in the method of FIG. 6.

Comparing FIG. 7B with FIG. 7C, the result of FIG. 7C is slightly more smoothed than the result of FIG. 7B. This is more clearly perceived by magnifying the results on a screen. The reason is as follows. In FIG. 7B, the minimum unit is a pixel since aliasing is compensated for on a pixel basis. However, in FIG. 7C, since a quadrangle including primitives forming a figure is generated and divided into a specified number of line segments, to transparent areas of which different transparencies are applied, a smooth color gradation is achieved, and anti-aliasing is more smoothly achieved from a view point of the user.

In certain embodiments, the method of FIG. 6 may provide enhanced smoothing when a rounding factor is processed.

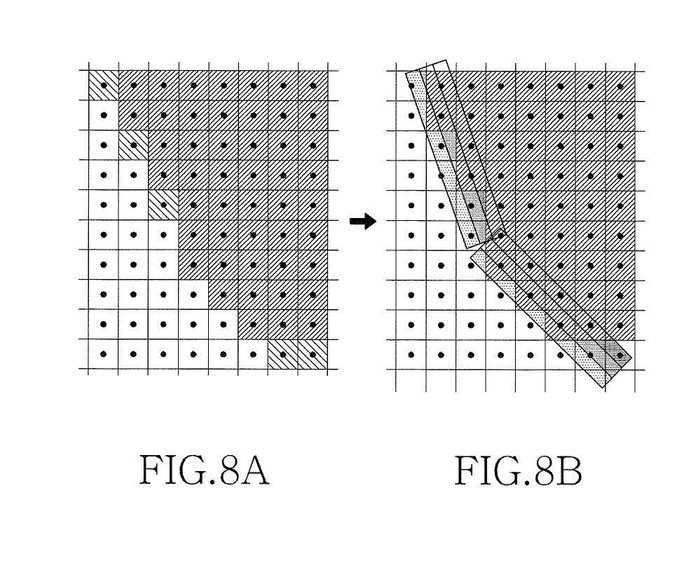

FIGS. 8A and 8B illustrate an example result after smoothed aliasing on a rounding primitive according to an embodiment of the present disclosure. FIG. 8A shows a result after smoothed aliasing is applied in the conventional method of sampling pixels, and FIG. 8B shows a result after smoothed aliasing is applied using the method of FIG. 6.

Comparing FIG. 8A with FIG. 8B, the result of FIG. 8A has a limitation to smoothly represent rounding since the method of smoothed aliasing on a pixel basis is used. Compared with FIG. 8A, FIG. 8B uses a method of determining a section of a primitive, generating at least one quadrangle that includes the determined section, and applying different transparencies to transparent areas of a specified number of line segments per quadrangle. Since this may cause two or more areas having different transparencies in a single pixel, an anti-aliasing effect may be better than that of FIG. 8A. This is clearly perceived with reference to FIGS. 9A and 9B.

FIGS. 9A and 9B illustrate example results of a screen after smoothed aliasing according to an embodiment of the present disclosure. FIG. 9A shows a result output on a screen after smoothed aliasing in a rounding part of a figure in the existing method of sampling pixels, and FIG. 9B shows a result output on a screen after aliasing is smoothed in the method of FIG. 6.

Comparing FIG. 9A with FIG. 9B, while the anti-aliasing as performed on FIG. 9A may not be satisfactory as the aliasing in the rounding part as viewed by the user, the aliasing in the rounding part of FIG. 9B is more smoothly processed than that of FIG. 9A.

According to the present disclosure, since aliasing is smoothed by generating an area including a form of data and applying different transparencies to transparent areas included in the generated area, an anti-aliasing is quickly performed in more detail compared with conventional anti-aliasing methods.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus for smoothed aliasing on a two-dimensional plane, comprising:
a data input unit configured to receive at least one piece of data inputted by a user;
a graphic engine processing unit configured to generate a quadrangle including a form of the at least one piece of data and differently applying transparency to at least one transparent area included in the quadrangle; and
a display unit configured to display the at least one piece of data processed by the graphic engine processing unit.

2. The apparatus of claim 1, wherein the at least one piece of data comprises at least one of a line, a circle, a curve, and a polygon.

3. The apparatus of claim 1, further comprising a data controller configured to divide the quadrangle including the form of the at least one piece of data into a specified number of line segments.

4. The apparatus of claim 3, wherein the data controller is configured to calculate a transparent area and an opaque area of each of the line segments, determine a transparency to be applied to each of the line segments based on a ratio of the transparent area to the opaque area, and transmit the determined transparencies to the graphic engine processing unit.

5. The apparatus of claim 4, wherein the data controller is configured to determine the transparencies differently for the line segments, and apply each of the differently determined transparencies to a transparent area included in a line segment.

6. The apparatus of claim 1, wherein the at least one piece of data comprises a primitive.

7. The apparatus of claim 6, wherein the primitive comprises a set of lines.

8. A method of smoothed aliasing on a two-dimensional plane, comprising:
receiving at least one piece of data inputted by a user;
generating a quadrangle including a form of the at least one piece of data;
differently applying a transparency to at least one transparent area included in the quadrangle; and
displaying the at least one piece of data.

9. The method of claim 8, wherein the at least one piece of data comprises at least one of a line, a circle, a curve, and a polygon.

10. The method of claim 8, further comprising dividing the quadrangle including the form of the at least one piece of data into a specified number of line segments.

11. The method of claim 10, further comprising calculating a transparent area and an opaque area of each of the line segments, and determining the transparency to be applied to each of the line segments based on a ratio of the transparent area to the opaque area.

12. The method of claim 11, further comprising differently determining the transparencies differently for the line segments, and applying each of the differently determined transparencies to a transparent area included in a line segment.

13. The method of claim 8, wherein the at least one piece of data comprises a primitive.

14. The method of claim 8, wherein the primitive comprises a set of lines.

15. Code implemented on a computer-readable medium, when executed by a computer, operable to perform at least the following:
receive at least one piece of data inputted by a user;
generate a quadrangle including a form of the at least one piece of data;
differently apply a transparency to at least one transparent area included in the quadrangle; and
display the at least one piece of data.

16. The code of claim 15, wherein the at least one piece of data comprises at least one of a line, a circle, a curve, and a polygon.

17. The code of claim 15, further comprising dividing the quadrangle including the form of the at least one piece of data into a specified number of line segments.

18. The code of claim 17, further comprising calculating a transparent area and an opaque area of each of the line segments, and determining the transparency to be applied to each of the line segments based on a ratio of the transparent area to the opaque area.

19. The code of claim 17, further comprising differently determining the transparencies differently for the line segments, and applying each of the differently determined transparencies to a transparent area included in a line segment.

20. The code of claim 15, wherein the at least one piece of data comprises a primitive.
